(19) United States
(12) Patent Application Publication
(10) Pub. No.: US 2010/0326363 A1
(43) Pub. Date: Dec. 30, 2010

(54) FEED WAGON FOR FEEDING ANIMALS SUCH AS COWS

(75) Inventor: Karel Van Den Berg, Bleskensgraaf (NL)

Correspondence Address: HOWREY LLP-EU, C/O IP DOCKETING DEPARTMENT, 1299 Pennsylvania Avenue, NW, Room B-3, Washington, DC, 20004-2402, US

(73) Assignee: MAASLAND N.V., MAASSLUIS (NL)

(21) Appl. No.: 12/525,857

(22) PCT Filed: Jan. 24, 2008
(86) PCT No.: PCT/NL2008/000027

§ 371 Date: Aug. 5, 2009

(30) Foreign Application Priority Data
Feb. 6, 2007 (NL) 1033349

(51) Int. Cl. A01K 5/02; A01K 5/00; B01F 9/10

(52) U.S. Cl. 119/57.92

(57) ABSTRACT

A feed wagon for feeding animals such as cows comprises an autonomous vehicle, a container for containing feed, wherein the container has at least one aperture for filling and emptying the container, and a connection between the autonomous vehicle and the container. The container is substantially cylindrical and rotatable about its axial axis, the container having an operative position for receiving and/or mixing feed and an unloading position for unloading the feed. The connection between the autonomous vehicle and the container comprises a tilt axis, the cylindrical container being tiltable about the tilt axis between the operative position and the unloading position relative to the autonomous vehicle. The invention further comprises a system for feeding animals such as cows, comprising such a feed wagon.

### CROSS REFERENCE TO RELATED APPLICATIONS

This application is a continuation of international application no. PCT/NL2008/000027, filed on Jan. 24, 2008, and claims priority from Netherlands application no. 1033349 filed on Feb. 6, 2007. The contents of both applications are hereby incorporated by reference in their entirety.

### BACKGROUND OF THE INVENTION

1. Field of the Invention

The invention relates to a feed wagon for feeding animals such as cows, and relates particularly to a feed wagon comprising an autonomous vehicle.

2. Description of the Related Art

EP 0 739 161 discloses a feeding device for feeding animals such as cows. The feeding device comprises a feed wagon with a container for feed which is disposed on an autonomous vehicle which is capable of finding its own way in the shed and from and to the places where a stock of feed is located. In the container there are provided augers for mixing feed in the container and for supplying feed from the container.

EP 4,444,509 discloses a stationary feeding device for feeding animals such as cows. The feeding device comprises a cylindrical container, which is provided at its inner side with a profile section which extends in a helical line, for mixing feed present in the container. The cylindrical container is rotatable about its axial axis. There is an auger for discharging feed from the container.

A drawback of the known feeding devices is that the auger used for discharging the feed from the container leads to an expensive and complicated construction.

### BRIEF SUMMARY OF THE INVENTION

The invention aims at providing an improved feed wagon for feeding animals. The feed wagon comprises an autonomous vehicle, a container for housing feed, wherein the container comprises at least one aperture for filling and emptying the container and an axial axis, and is substantially cylindrical and rotatable about the axial axis. The feed wagon has a rotatable cylindrical container and is capable of mixing feed. Preferably, the container has an operative position for receiving and/or mixing feed and an unloading position for unloading the feed. The container is moved between the operative position and the unloading position by tilting the container about a tilt axis. Preferably, the unloading position is chosen in such a manner that, when the container is in the unloading position, the gravitational force will contribute to effect the unloading of the feed.

The unloading position may be chosen in such a manner that in the unloading position the feed will slide from the container under the influence of the gravitational force.

The container of the feed wagon may also have a plurality of unloading positions, for example a first unloading position in which the feed is unloaded on the left side of the feed wagon and a second unloading position in which the feed is unloaded on the right side of the feed wagon. It is also possible for the feed wagon to have a plurality of operative positions. It should be noted that each of the terms operative position and unloading position may not only comprise one single position, but also an operative position area and an unloading position area, respectively.

In one embodiment, the tilt axis of the connection between the autonomous vehicle and the container is substantially perpendicular to the axial axis of the container. In another embodiment, the tilt axis extends substantially in the main direction of travel of the autonomous vehicle. The main direction of travel is the direction in which the autonomous vehicle moves straight forward. In that case, the axial axis of the container extends in a vertical plane which is substantially perpendicular to the tilt axis.

In one embodiment, where the container has an aperture for filling and emptying the container at one of the axial ends, the operative position of the container is chosen in such a manner that the axial axis of the container then extends vertically, where the container's axial end in which the aperture is provided is located at the upper side. If the container is in the operative position, it is possible for the container to rotate in order thus to mix the feed present therein without the feed falling from the container and without the necessity of closing the aperture. The unloading position may then be chosen in such a manner that in the unloading position the axial axis of the container will tilt over more than 90 degrees relative to the vertical. Advantageously, the container is tiltable in two opposite directions, preferably sideward, over more than 90° relative to the vertical. As a result thereof, no additional unloading device, such as a transverse conveyor belt, is needed for dropping feed and the like at one side (or two sides) of the vehicle. Furthermore, it is thus possible for the vehicle to drop feed outside its own direction of movement, which is advantageous with respect to contamination or damage of the feed, and to drop the feed during moving, which improves the efficiency.

The system further comprises a rotatable and/or adjustable tilt axis. There will thus be more flexibility with respect to the operative position(s) and/or unloading position(s) to be chosen.

As an alternative to unloading by tilting the container or in addition thereto, unloading may also take place through the use of an auger or a conveyor belt.

Advantageously, the system comprises a casing of the rotatable container, the casing being not rotatable, but, if desired, tiltable relative to the vehicle.

In one embodiment, a profile section is disposed at the inner wall of the container, wherein the profile section protrudes relative to the inner wall of the container. The profile section preferably extends in a helical line. By rotating a container with a profile section on the inner wall, the mixing of the feed in the container is promoted. Moreover, when mixing the feed in a known container which is provided with an auger, the feed will be pressed against the wall of the container. This leads to considerable wear, both of the inner wall of the container and of the auger used for mixing. Using a container with a profile section at the inner wall results in less wear.

The profile section extending in a helical line may also be applied to obtain a uniform unloading of the feed from the container. In particular, if the container rotates in such a manner that the pitch of the profile section extending in a helical line acts opposite to the direction of travel of the autonomous vehicle, this is found to provide in practice a very uniform unloading.

The autonomous vehicle may be provided with wheels, whether or not provided with caterpillar tracks. The wheels may be arranged to drive over a floor surface, but also to guide the autonomous vehicle, if the latter is suspended from a rail, along said rail. In one embodiment, the feed wagon also comprises a drive for driving at least one wheel, the drive comprising an electric motor for each wheel to be driven. In one embodiment, this electric motor is a servo-motor which is directly connected to the wheel to be driven. This leads to a simple and robust construction.

The autonomous vehicle may drive unmanned, but may also be self-propelled with a driver or a supervisor. The autonomous vehicle may be guided automatically with the aid of guide device, beacons or sensors. Control through use of a GPS is also possible.

In one embodiment, the feed wagon comprises at least one weighing device for determining the mass of the feed which is present in the container. It is possible that an outgoing signal of the weighing device is supplied as an ingoing signal to a control of the feed wagon, the control being arranged to control one or more of a tilting of the container, a driving speed of the wagon, a direction of rotation of the container and an rpm of the container in dependence on a change over time of the mass of the feed measured by the weighing device. An unloading and/or an unloading speed of the feed may thus be controlled, because it is possible for the control to determine an unloading speed on the basis of a measured change of the mass of the feed in the container, and to influence the speed via the tilting, the direction of rotation and/or the rpm of the container, through use of or in combination with influencing the driving speed of the wagon. In order to achieve one or more of such influencing measures, the control may control motors or other drive mechanisms of the feed wagon that drive the container and/or the wagon. There may further be added an angle gauge, an rpm gauge, and/or a speedometer in order to measure an angle of the container, the rpm of the container and the speed of the wagon, respectively, and to supply these data to the control through the use of a suitable signal. In another embodiment, an initial angle adjustment for unloading may be effected on the basis of an expected parameter, such as a curve or other relation between unloading angle and outflow speed, or on the basis of a self-learning control based on, for example, data from previous unloadings.

In one embodiment, the feed wagon further comprises a slide element for displacing feed lying on a surface over which the autonomous vehicle moves. This slide element may slide, during driving of the autonomous vehicle, the feed present on the floor closer to the feeding gate and/or redistribute the feed over the floor.

In one embodiment, a detector determines the amount of feed present on a particular surface located outside the container and/or determines the distribution of the feed over a particular surface located outside the container. An example of a suitable detector is a 3D-camera or an ultrasonic sensor.

The invention also provides a system for feeding animals such as cows, which system comprises a feed wagon as described above, as well as a filling station for filling the container of the feed wagon, a storage for at least one sort of feed and a conveyor for conveying at least one sort of feed from the storage to the filling station.

In one embodiment, the system further comprises a rail for guiding the autonomous vehicle. In that case, the autonomous vehicle is preferably arranged to be suspended from the rail. The filling station may, for example, be provided with a funnel for guiding the feed to the vehicle.

In another embodiment, the autonomous vehicle comprises one or more chargeable batteries, and the filling place comprises an energy source for supplying energy to the feed wagon for recharging the chargeable batteries.

In a further embodiment, the system according to the invention further comprises a mixing device for mixing different types of feed before the feed is brought into the container. It is possible for the feed, after it has been brought into the container, to be mixed additionally by rotation of the container about its axial axis.

In a possible embodiment, the system according to the invention further comprises a drive mechanism for rotating the container when the feed wagon is located in the filling place. In that case, the feed wagon need not comprise a drive for rotating the container.

In practice, it may occur that the feed wagon is connected in each case to an energy source only for a relatively short period of time (for example, in each case upon filling the wagon at the filling point, if the energy source is provided there), this period of time being shorter than a charging time needed to charge the batteries completely or almost completely. As a result thereof, in each case upon charging, a relatively small amount of energy will be supplied to the batteries, after which energy is abstracted for a load, such as electric motors and/or a control device of the feed wagon. As a result thereof, a problem of degeneration of one or more batteries may occur, because these are not or at least insufficiently recharged from the electric energy source to reach a condition of being charged completely such as may be desired in some battery technologies in order to prevent or at least to reduce a degeneration of the battery. An example of batteries in which such a degeneration may occur is a lead battery, such as a lead sulphate battery. Using these batteries in a partially charged condition causes a deposit is formed on one or more of the battery plates. Owing to the deposit, a degeneration of the batteries may occur.

In the context of this problem, in one embodiment, the feed wagon comprises at least two chargeable batteries, a charging connection for effecting an electrical connection between the feed wagon and an energy source, a charging device for charging the batteries, a switching device for effecting an electrical connection between one of the batteries and a load to be supplied with energy by the relevant battery, and for effecting an electrical connection of an entrance of the charging device to another one of the batteries, and a control device which is arranged to control the switching device and/or the charging device for:
a) charging the batteries through the use of the charging device when the charging connection has been connected to the energy source;
b) connecting a first one of the batteries to the load in order to supply electrical energy to the load;
c) operating the charging device in order to charge the second battery, the first battery supplying electrical energy to the charging device;
   repeating b) and c) after a predetermined criterion has been reached, wherein in b) the second battery has been connected to the load in order to supply energy to the load and in c) the first battery is charged by the charging device from the second battery.

When the feed wagon has been connected to the electrical energy source, the batteries are charged or recharged, whether or not via the charging device, from the electrical energy source. In order to effect further charging of a battery, after charging or recharging from the energy source, one of the batteries may be charged additionally, via the charging device, from one or more of the other batteries. Therefore, the above-mentioned step c) may also be described as charging the second battery, through use of the charging device, from the first battery. The battery that may be charged additionally (designated above as the second battery) is preferably not used for supplying energy to the load during such an additional charging, in order to facilitate further charging. One or more of the remaining batteries will supply energy to the load and/or will supply the energy needed for charging the second battery. In the above-mentioned example of the lead sulphate battery, by further charging of the relevant battery, a cleaning, for example burning clean, of battery plates may be started, which may at least partially remove the possibly formed deposit. As a result thereof, a degeneration development of the battery may be influenced in a positive manner.

The activity b) may take place during the charging of the batteries from the external energy source, and be continued after the electrical connection to the external energy source has been broken. It is also possible that this only takes place after the electrical connection to the external energy source has been broken. The second battery will preferably only be charged from the first battery (step c) after the electrical connection between the charging connection and the external energy source has been broken, so that charging of the batteries will take place as much as possible from the external energy source.

The charging of the second battery may take place until a predetermined criterion is reached, such as a predetermined voltage or other criteria such as indicated below, in order to indicate thereby a complete or sufficient charging of the relevant second battery. Subsequently, a change of the batteries may take place, in other words, another one of the batteries may be charged from one or more of the remaining batteries. Incidentally, it should be noted that the term charging may comprise any desired form of charging, such as continuous charging, drop charging, etc.

In this manner each of the batteries may alternately be charged to such a level that it will thus be possible to prevent, at least partially, a degeneration caused by operating the batteries at a too low level of charging.

Incidentally, it should be noted that the term first battery and second battery should not be interpreted in such a manner that there are provided only two batteries: the principle described here may be applied with any number of at least two batteries.

The expression “controlling the switching device and/or the charging device” should be understood as controlling at least one of the switching device and the charging device.

The batteries may comprise any form of storage of electrical energy, such as a storage in a chemical form in, for example, a NiCd, Pb, PbS, NiMH or other chargeable cell or battery of cells.

The energy source may comprise any electrical energy source, such as a lighting mains connection, a lighting mains adapter, a stationary battery, or an element fed by solar energy or other energy sources.

The predetermined criterion may comprise a charging condition of the second battery, so that the recharging of the second battery may take place until a predetermined charging condition has been reached in order to reduce or counteract the mentioned degeneration phenomena. There may be provided a measuring device for measuring the criterion, for example for measuring the charging condition of the second battery.

The predetermined criterion may also comprise one or more of a voltage, a voltage development, an impedance and an impedance development of the second battery, or other criterion to be able to determine the charging condition of the battery.

The control device may further be arranged to measure a charging condition of the second battery previously to step c) and only to proceed to step c) when the second battery has reached a recharging phase. By only charging the second battery from the first battery when the recharging phase is reached, it is possible to limit as much as possible a loss of energy upon charging the second battery from the first battery by only starting the charging of the second battery from the first battery at the moment when the second battery has reached the recharging phase, so that a limited charging of the second battery from the first battery is still needed.

The term recharging phase should be understood to be a phase of the charging process of a battery in which the battery has substantially been charged, for example to a predetermined percentage of the maximum capacity, to a predetermined charging voltage and the like. For example, the recharging phase may be determined as beginning at 90% of the capacity of the battery or as beginning at a charging voltage which is approximately 30% above a nominal voltage of the battery. With a 12 Volt battery the recharging phase may therefore be defined, for example, as beginning at 16.3 Volt charging voltage at a predetermined charging current that amounts, for example, to 10% of a maximum charging current. The recharging phase may also be defined as the phase of the charging process in which a regeneration of the battery takes place, thus in the aforementioned example of the lead sulphate battery the phase of the charging process in which burning clean of the battery plates occurs. In the state of the art, the term recharging phase is also designated as a drop charging phase. However, it should be noted that recharging may take place in any arbitrary manner, and is thus not limited to a drop charging, but may also comprise charging at a constant current, constant voltage, constant capacity, etc.

The charging device may comprise a voltage converter for converting the voltage received via the charging connection into a charging voltage for the batteries, and for converting the voltage received from the at least one first battery into a charging voltage for the second battery. Of course, it is also possible that the voltage received via the charging connection is led to the batteries without intervention of the charging device, when, for example, a voltage supplied via the charging connection has a suitable value.

The switching device may comprise any sort of switch for switching an electrical connection, such as electromechanical switches (for example relay or motor controlled switches), or semiconductor switches (such as transistors, transistor arrays, thyristors or other semiconductor switching elements). It is also possible that one or more of the electrical connections are effected by releasing, through use of a release signal, a relevant entrance or exit of, for example, the charging device.

The charging connection may comprise a conducting electrical connection, but there may also be applied a different form of energy transmission, for example an inductive or capacitive transmission, for which purpose the device such as the feed wagon may be provided with a suitable receiver for receiving the energy to be transmitted from the energy source.

The control device may constitute part of the aforementioned control of the feed wagon.

Since the principle described here is in particular advantageous if (as mentioned before) the charging of the batteries via the charging connection is in each case of short duration in proportion to a total charging time to charge the batteries completely, the control device is preferably arranged to change the batteries after charging the batteries at least twice from the energy source.

The principle described here for charging the batteries is not only applicable as an embodiment of the feed wagon, but is, on the other hand, also applicable for any device fed by two or more chargeable batteries. Therefore, according to an aspect of the invention, a device for operating batteries comprises: at least two chargeable batteries, a charging connection for effecting an electrical connection between the feed wagon and an energy source, a charging device for charging the batteries, a switching device for effecting an electrical connection between one of the batteries and a load to be supplied with energy by the relevant battery, and for effecting an electrical connection of an entrance of the charging device to another one of the batteries, and a control device which is arranged to control the switching device and/or the charging device for:
a) charging the batteries with the charging device when the charging connection has been connected to the energy source;
b) connecting a first one of the batteries to the load in order to supply electrical energy to the load;
c) operating the charging device in order to charge the second battery, the first battery supplying electrical energy to the charging device;
repeating b) and c) after a predetermined criterion has been reached, wherein in b) the second battery has been connected to the load in order to supply energy to the load and in c) the first battery is charged by the charging device from the second battery.

In a further aspect of the invention, there is provided a method of operating at least two chargeable batteries, comprising:
a) charging the batteries with the charging device when the charging connection has been connected to the energy source;
b) connecting a first one of the batteries to the load in order to supply electrical energy to the load;
c) operating the charging device in order to charge the second battery, the first battery supplying electrical energy to the charging device;
repeating b) and c) after a predetermined criterion has been reached, wherein in b) the second battery has been connected to the load in order to supply energy to the load and in c) the first battery is charged by the charging device from the second battery.

### BRIEF DESCRIPTION OF THE DRAWINGS

The invention will be explained hereinafter in further detail with reference to a drawing, in which an exemplary embodiment is shown in a non-limiting manner, in which:

FIG. 1 shows a general view of the system according to the invention,

FIG. 2 shows a side view of the feed wagon according to the invention,

FIG. 3 shows a top view of the feed wagon according to FIG. 2,

FIG. 4 shows a front view of the feed wagon according to FIG. 2, with the container in the operative position,

FIG. 5 shows a front view of the feed wagon according to FIG. 2, with the container in the unloading position,

FIG. 6 shows a schematic diagram of a circuit according to an aspect of the invention,

FIG. 7 shows a flowchart which illustrates the operation of the circuit according to FIG. 6,

FIG. 8 shows a charging voltage curve and a charging current curve of a battery, and

FIG. 9 shows a schematic diagram of a circuit according to an aspect of the invention.

### DESCRIPTION OF ILLUSTRATIVE EMBODIMENTS

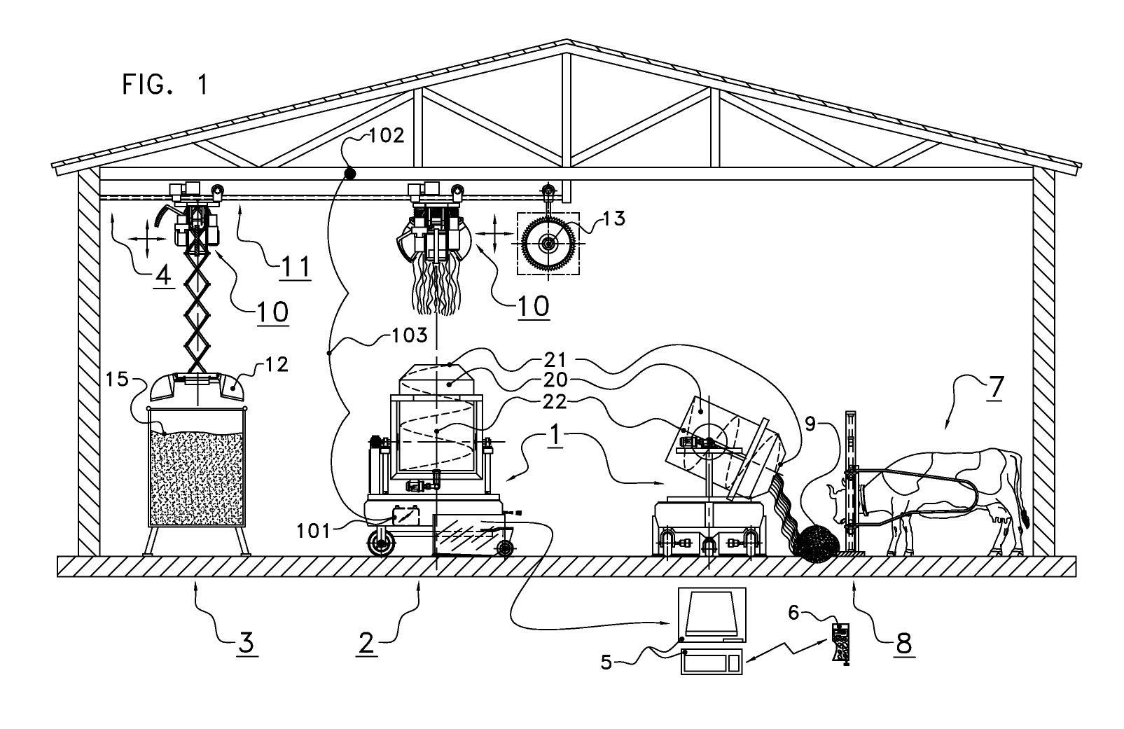

The following is a description of certain embodiments of the invention, given by way of example only and with reference to the drawings. FIG. 1 shows a general view of the system according to the invention. The system of FIG. 1 comprises a feed wagon 1, a filling station 2 for filling the feed wagon 1, a storage 3 for storing at least one sort of feed and a conveyor 4 for conveying at least one sort of feed from the storage 3 to the filling station 2. The system may be provided remotely with control data via a computer 5 and/or PDA 6. The system is intended to supply feed to cows 7 which are, for example, standing at a feeding gate 8. The system ensures that feed 9, which may consist of one or a plurality of feed components, will be provided at the feeding gate 8.

In the present embodiment, storage 3 comprises a plurality of sorts of feed, such as, for example, any arbitrary combination of (ensilaged) grass, maize, brewer's grains, pulp, pellets, biks, potato fibres, and/or hay. The sorts of feed and the number of different sorts of feed applied depend on the needs of the animals to be fed and the farmer's wishes. Preferably, storage 3 comprises a plurality of silos 15, of different types, if desired.

Conveyor 4 comprises a trolley 10 which is suspended from the rail 11. The trolley has a gripper 12 which grips a portion of feed from a silo 15. The trolley 10 receives, via a control system, the command to take a particular amount of feed from a particular silo 15.

Giving the command to take a particular amount of feed of a particular type from a particular silo 15 may be initiated from a central control system at a predetermined point of time or because a particular condition occurs in the shed or at the feed wagon. The feed wagon 1 may, for example, observe that there is too little feed at a particular part of the feeding gate 8, and may give, based on that observation, via wireless communication, a command to the trolley 10 to compose a portion of feed for the group of cows 7 which use that part of the feeding gate 8 where the feed should be replenished.

After taking an amount of feed, the gripper 12 keeps the feed while the trolley 10 moves along the rail 11 to the filling place 2. At the filling place 2 the feed wagon 1 is ready.

The gripper 12 drops the amount of feed at the filling place 2 into the container 20 of the feed wagon 1. For this purpose, the container 20 is provided with an aperture 21. When the gripper 12 of the trolley 10 has dropped feed into the container 20 of the feed wagon 1, the container 20 will rotate about its axial axis 22. As a result thereof, the feed will be loosened up.

Meanwhile, the trolley 10 takes the gripper 12 back to the storage 3. The gripper 12 descends again to the stock of feed in a silo, and subsequently takes again an amount of feed from a predetermined silo 15. The feed taken by the gripper 12 at the second time may be of the same type as the feed that was taken at the first time or may be of another type. The trolley 10 moves again to the filling place 2, and the gripper 12 unloads again the feed into the container 20 of the feed wagon 1. By the rotation of the container 20 about its axial axis 22 the feed that was supplied by the gripper 12 at the second time is mixed with the feed that was supplied by the gripper 12 at the first time.

This is repeated until the desired amount of feed in the desired composition is present in the container 20 of the feed wagon 1.

Optionally, there is provided, in the filling place 2, at the storage 3 or between the storage 3 and the filling place 2, a milling cutter 13 for loosening up roughage such as ensilaged grass. In one embodiment, there may also be fastened a cutter device to the feed wagon.

When the desired amount of feed in the desired composition is present in the container 20 of the feed wagon 1, the feed mixture is additionally mixed by rotation of the container. If desired, water is added. When filling and mixing are sufficient, the feed wagon 1 leaves the filling place 2 and moves to the shed.

The feed wagon 1 moves in the shed to the place at the feeding gate 8 where too little feed is present and unloads there the feed from the container 20.

When moving through the shed the feed wagon detects the amount of feed lying at the feeding gate 8 and the distribution of the amount of feed over the length of the feeding gate 8. The detection results are preferably fed back to the central control system and/or to the control system of the trolley 10.

In another variant of the system for feeding animals according to the invention, there is provided, between the storage 3 and the filling place 2, a buffer for the temporary storage of feed and/or feed mixtures.

Instead of or in addition to the filling of the container 20 of the feed wagon 1 by means of the trolley 10, the container 20 may also be filled in another manner, for example by means of an auger which is fixedly disposed in the filling place and which conveys feed from an intermediate buffer or from the storage to the filling place and brings the feed into the container 20.

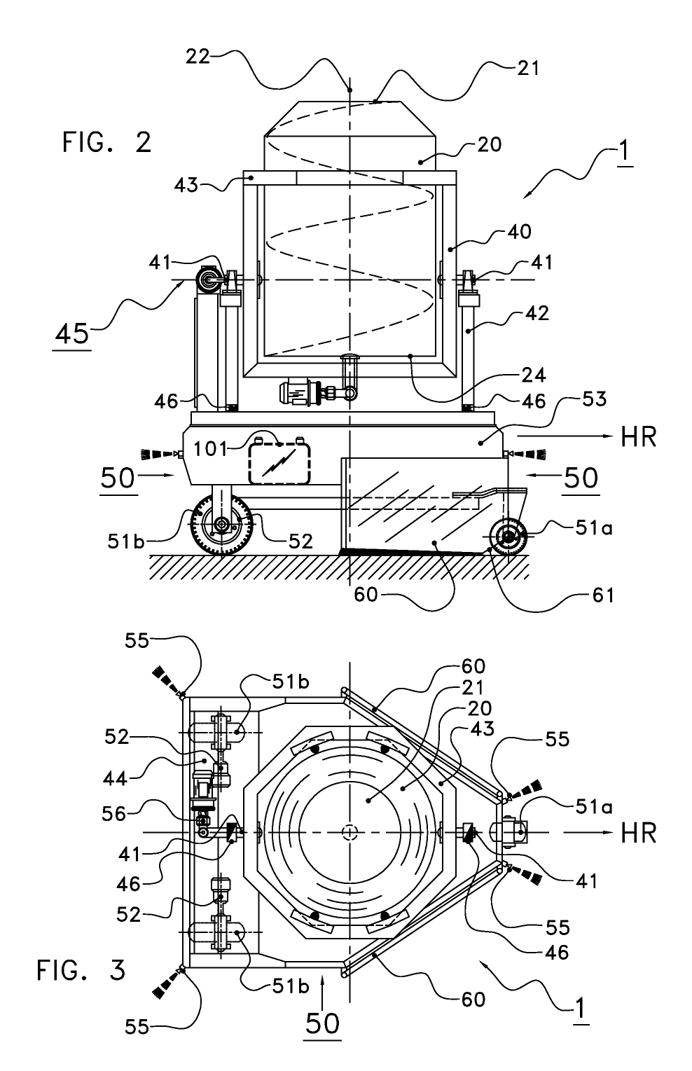

FIG. 2 shows a side view of one embodiment of the feed wagon according to the invention. The feed wagon 1 comprises a container 20. The container has an aperture 21 and an axial axis 22. The container 20 is cylindrical and rotatable about its axial axis 22. The aperture 21 may be closable, but not necessarily. The container has, for example, a content of approximately 1 m³.

The feed wagon further comprises an autonomous vehicle 50. This vehicle 50 has a main direction of travel HR. The main direction of travel HR is that direction in which the vehicle 50 moves straight forward.

In this embodiment, the autonomous vehicle 50 is provided with three wheels 51. At the front side there is one wheel 51a. The wheel 51a is a steering wheel, and can thus also rotate about a vertical axis. The rear wheels 51b are driven wheels. Each of the rear wheels 51b is provided with its own servomotor 52 which drives the wheel. The servomotors 52 are individually controlled. If there is created a difference in the speed of rotation between the servomotors 52, the autonomous vehicle 50 will make a curve. If there is no difference between the speed of rotation of the two servomotors 52, the autonomous vehicle 50 will move straight forward or straight backward.

In an alternative, not shown embodiment, the autonomous vehicle 50 may be provided with four or more wheels, which wheels are whether or not provided with caterpillar tracks.

The feed wagon 1 further comprises a connection 40 between the autonomous vehicle 50 and the container 20. The connection 40 comprises a tilt axis 45 which ensures that it will be possible for the container 20 to tilt relative to the autonomous vehicle 50. The tilt axis 45 need not be a physical, through-going shaft, but may also be designed as two axle journals 41 being in alignment. In that case, the tilt axis 45 is the mathematical axis about which the container tilts.

In the embodiment shown in FIG. 2, the connection 40 further comprises a yoke 42 which carries the container 20 and a ring 43 which extends around the circumference of the container 20. The container 20 may rotate about its axial axis 22 relative to the ring. In an alternative embodiment, there is no ring, but the yoke 42 rotates along with the container 20 when the container rotates about its axial axis 22.

FIG. 3 shows a top view of the embodiment of the feed wagon according to FIG. 2. Also in this top view, the container 20 with the aperture 21 and the autonomous vehicle 50 can be recognized. The wheels 51a, 51b and the servomotors 52 are (partially) indicated by dashed lines because they are located below the chassis 53 of the autonomous vehicle 50.

In the top view of FIG. 3 a transverse beam 44 is fastened to the yoke 42. This transverse beam 44 lies near its ends on an electronic weighing device 46. Near each end of the transverse beam 44 there is a weighing device 46. At the side of the yoke 42 where there is no transverse beam, the yoke 42 is supported on a third electronic weighing device 46. With this arrangement of three weighing devices 46, it is possible to determine both the weight and the centre of gravity of the filled container 20.

In an alternative, not shown embodiment, it is possible to apply only one weighing device. In that case, by means of this weighing device it is only possible to determine the weight of the filled container 20, not the centre of gravity.

In one embodiment, the container 20 is provided with an ultrasonic sensor which is located near the highest point (when the container 20 is in the operative position). Said ultrasonic sensor “looks” into the container 20 and thus determines the volume of the feed present in the container 20.

The chassis of the autonomous vehicle is provided at its corners with proximity sensors 55, for example designed in the form of ultrasonic sensors. When the autonomous vehicle comes too close to an object, animal or human being, at least one of the proximity sensors supplies a signal to the control of the vehicle. This signal may then stop the vehicle and/or supply a warning signal, for example in the form of a light and/or a sound signal. The autonomous vehicle is preferably further provided with an emergency stop. The emergency stop is preferably designed in the form of a bumper, the emergency stop being operated as soon as the bumper hits something.

For navigation purposes the autonomous vehicle 50 is preferably provided with a gyroscope 56. In that case, the gyroscope 56 is used in the feedback of a control which is used for controlling the autonomous vehicle 50.

The autonomous vehicle 50 may find its way through the above-described control using the servomotors 52 of the driven wheels 51b, preferably in combination with the gyroscope 56 which is included in the feedback loop of the control. As an alternative, the autonomous vehicle 50 may also find its way by means of GPS, with the aid of beacons disposed in the floor or elsewhere in the shed, by making use of detection of the grid of concrete iron in the floor of the shed or with the aid of a camera, preferably designed as a 3D-camera.

Preferably, the feed wagon 1 is provided with a slide element 60 on one or both of its lateral sides. The lower side of this slide element 60 is located somewhat above the floor. By means of the slide element 60 feed lying on the shed floor may be slid aside. It is thus possible to slide feed closer to the feeding gate. In an alternative embodiment, the slide element 60 may also be located at the front side or the rear side of the feed wagon.

In one embodiment, the slide element 60 is movable to some extent in vertical and, possibly, also in horizontal direction. In that case, the slide element 60 is preferably disposed resiliently. In another embodiment, the slide element 60 is provided with an oblique side 61 at the front side (seen in the main direction of travel), as shown in FIG. 2. These features ensure that the slide element is less hindered by obstacles on the floor.

Instead of a slide element, a rotatable wheel may also be applied.

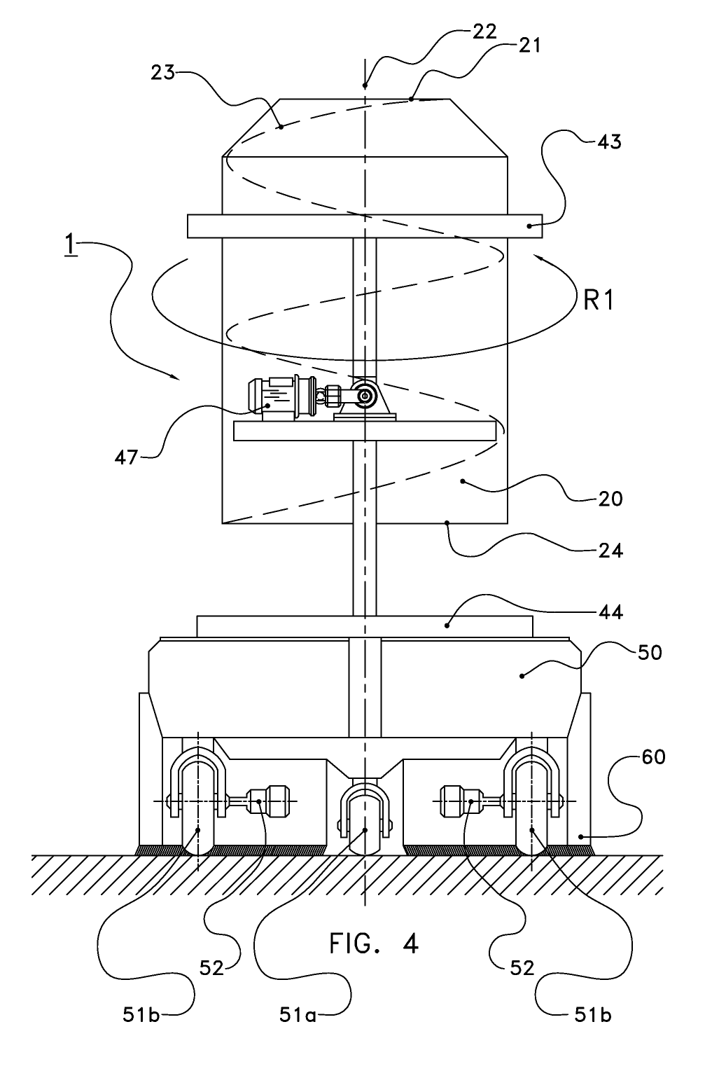

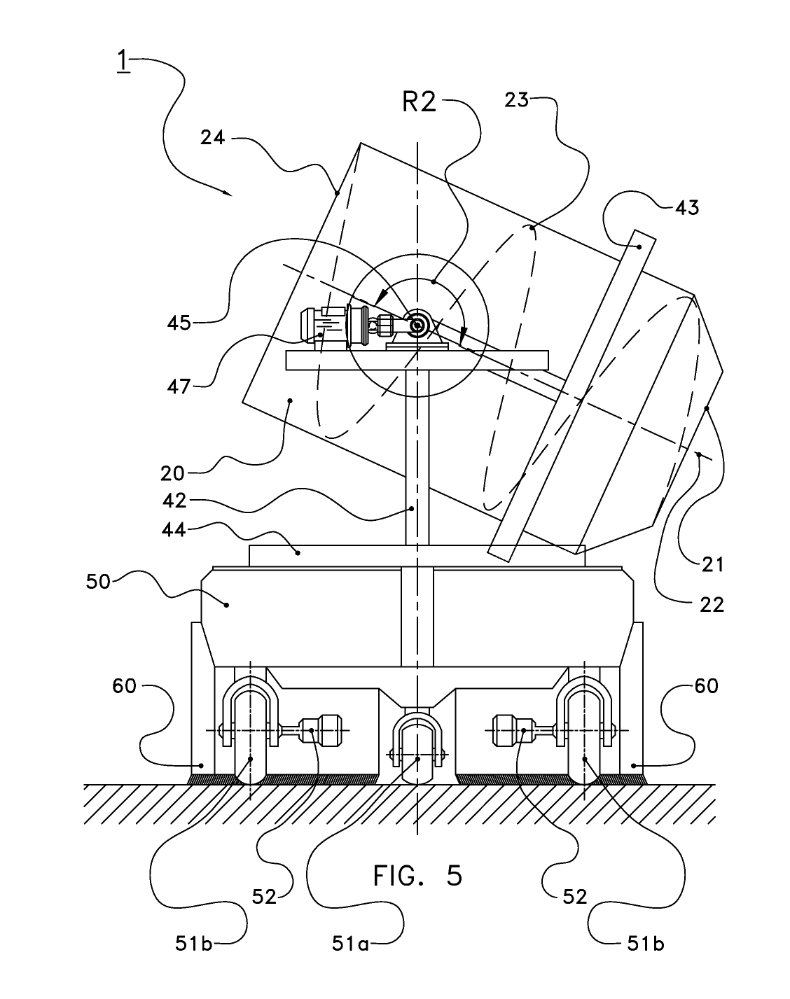

FIG. 4 shows a front view of the embodiment of the feed wagon according to FIG. 2, with the container in the operative position, while FIG. 5 shows a front view of the embodiment of the feed wagon according to FIG. 2, with the container in the unloading position.

FIGS. 4 and 5 also show the profile section 23 which extends in a helical line and which is disposed at the inner side of the container 20. The profile section 23 protrudes inwardly relative to the inner wall of the container 20. Other ways of extending than in a helical line are also possible, for example straight or corrugated profile sections extending diagonally or in axial direction of the container 20. In one embodiment, the profile section protrudes approximately 100 mm relative to the inner wall. It has been found that this profile section height gives good results in combination with a container having a diameter of approximately 1000 mm.

In the operative position as shown in FIG. 4, the container 20 is upright. The feed to be mixed and distributed is dropped into the container 20 via the aperture 21 which is in the upper part of the container 20 when the latter is in the operative position.

The container is rotatable about its axial axis 22 in the direction of rotation R1. Incidentally, the direction R1 may also be in the opposite direction relative to the direction of rotation R1 indicated in FIG. 4. By the rotation of the container 20 about its axial axis 22 the feed present in the container will be loosened up and mixed. It is found that the mixing of the feed by rotation of the container 20 takes less energy than the use of an auger. Preferably, the rpm of the container 20 is variable.

For a proper mixing, the container 20 makes an angle with the vertical. In practice, such an angle will often be between 25 and 65 degrees with respect to the vertical, in such a manner that the aperture 21 of the container will still be at a higher level than the bottom 24 of the container 20. The choice of the angle may—partially—be determined by the situation of the centre of gravity of the filled container 20.

When the feed wagon 1 has moved to the place where the feed should be unloaded, the container 20 will be brought into the unloading position. The unloading position is shown in FIG. 5. Compared with the operative position of FIG. 4, in the unloading position, the container 20 has tilted about the tilt axis 45 (arrow R2). This tilting is preferably effected by use of an electric motor 47 which is fastened to the yoke 42.

Preferably, the container 20 is tilted in the unloading position over more than 90° relative to the operative position. In that case, the feed will slide automatically from the container 20 under the influence of the gravitational force. Preferably, the feed wagon is provided with a sensor which measures the tilt angle of the container 20.

In one embodiment, it is possible for the container 20 to continue to rotate about its axial axis during unloading. By attuning the direction of rotation R1 of the container 20 to the pitch direction of the profile section 23 extending in a helical line, the unloading of the feed may be influenced. It is found that, when the profile section 23 leads the feed from the container 20 in a direction opposite to the direction of travel of the feed wagon, there is obtained a uniform unloading of feed.

By attuning the angle made by the container 20 with the vertical, the driving speed of the autonomous vehicle and the direction of rotation and the rotational speed of the container 20 about its axial axis 22 to each other, the unloading process can be managed properly. When controlling the unloading process, also the weight and the situation of the centre of gravity can be measured and taken into account in order to obtain a still further optimisation of the unloading process. Through a proper attuning even a global metering can be realized.

The drive of the container 20 is preferably realized through use of short-circuit armature motors, controlled by frequency regulators. The advantage of applying such motors is their robustness. If desired, the wheels may also be driven by short-circuit armature motors, controlled by frequency regulators.

In one embodiment, the container 20 is made of stainless steel. Other materials, such as for example carbon steel or synthetic material, are possible as well.

Preferably, the electric motors present on the feed wagon 1 are fed by chargeable batteries 101 present on, at or in the feed wagon 1. Preferably, in the filling place 2 or in the immediate vicinity thereof, there is provided a charging point 102 which is connectable to the batteries 101 (see FIG. 1). In this manner, the batteries can be recharged during the filling of the container 20.

The electrical connection 103 may be realized by a contact element 103 on the feed wagon, which makes contact with the charging point 102 when the feed wagon is located in or at the filling place 2. In that case, it is advantageous if the feed wagon 1 returns to the filling place 2 when the feed wagon is not being used. During the time in which the feed wagon 1 is not active, the batteries may then be recharged further.

The charging point may also be a rail which is under voltage.

In one embodiment, the feed wagon is provided with a converter which is capable of converting 220V alternating current voltage into 12V or 24V direct current voltage. In that case, the charging point may be connected directly to the lighting mains.

In another embodiment, on board of the feed wagon 1 there is at least one battery more than strictly necessary for feeding the electric motors and other electrical equipment on board of the feed wagon. This extra battery may be fed dropwise from one or more of the other batteries during operation of the feed wagon 1. When the extra battery has been recharged sufficiently, the electric system switches, so that the extra battery will be used for feeding the electric motors and other electric equipment on board, and one of the other batteries will be recharged. In this manner the use of the batteries rotates and no long standstill time of the feed wagon 1 is required for dropwise recharging of one or more batteries.

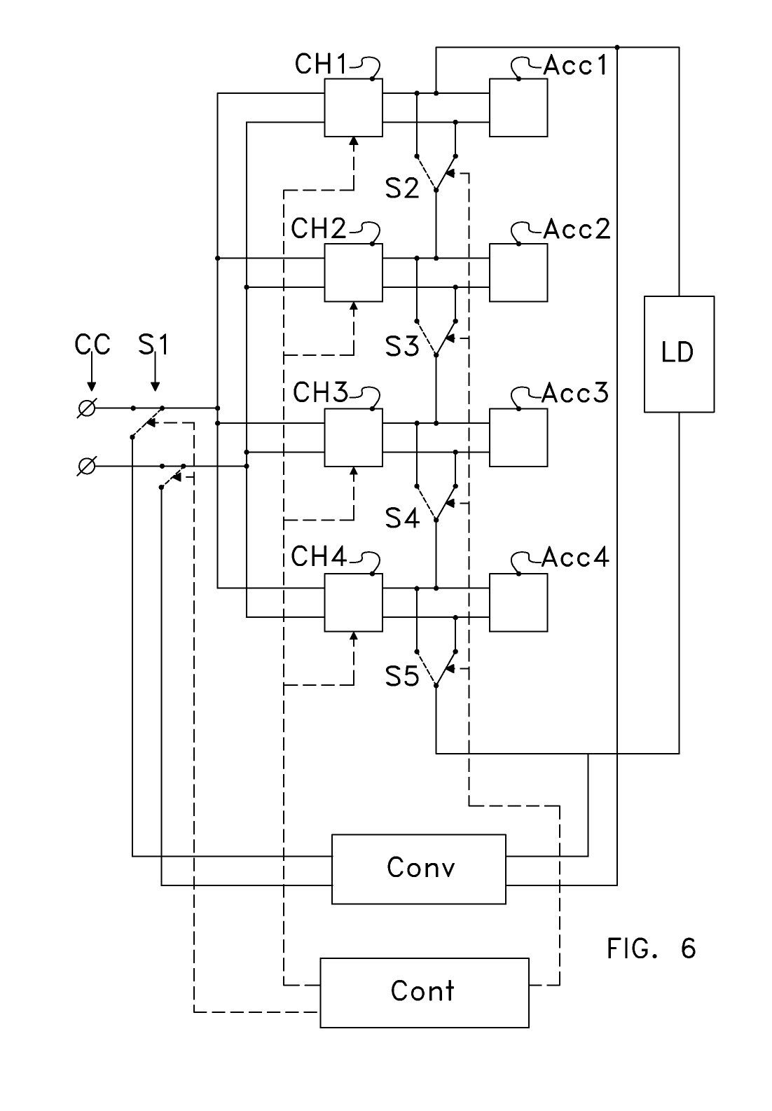

FIG. 6 shows 4 batteries designated as ACC1-ACC4 for supplying electrical energy to the load LD which, for example in the case of the feed wagon 1, may comprise a motor and/or a control system of the wagon. Each of the batteries may be charged via a respective charger CH1-CH4, for which purpose an exit of each of the chargers is electrically connected to connections of the relevant battery (whether or not via an optional, not shown switch) for interrupting an electrical connection between the relevant charger and battery in the case that no charging takes place. The chargers CH1-CH4 are connected to a charging connection CC (such as the above-mentioned electrical connection 103) for making contact with an energy source (also to be designated as feeding source), for example a lighting mains connection or the above-mentioned charging point 102. The chargers may each comprise a first converter for converting a voltage offered to the charger (for example an alternating current voltage such as a lighting mains voltage, or a direct current voltage) into a charging voltage for the relevant battery. Via Switch 51, which comprises a bipolar switch in this embodiment, the chargers may be connected either to the charging connection CC, or to a second converter CONV (for example a converter for converting direct current voltage into direct current voltage or a converter for converting direct current voltage into alternating current voltage). The second converter is arranged to convert a voltage of one of the batteries ACC1-ACC4 or of an assembly of two or more of the batteries, into a voltage for feeding one or more of the chargers CH1-CH4. Of course, it is also possible to omit the second converter and to offer the voltage supplied to the load directly to the chargers CH1-CH4 via the switch 51 in the case that the voltage supplied to the load is within an input voltage action area of the chargers CH1-CH4.

Further, switches S2-S5 are shown, each of them connecting one of the batteries to the load LD in a first (shown) position, and each of them disconnecting a relevant one of the batteries from the load in a second position. Thus, the switch S2 connects the battery ACC1 to the load LD in the first, shown position, and the switch S2 disconnects an electrical connection between the battery S2 and the load LD in the second position which is indicated by a dotted line.

FIG. 6 further shows a control device CONT (such as a suitably programmed microprocessor, programmable logical device such as a so-called PLD, microcontroller, personal computer or other suitable control implemented with hardware and/or software) that controls the switches S2-S5 and the chargers CH1-CH4 with control signal lines which are schematically shown in FIG. 6 and which may comprise separate lines, a bus structure or any other control. The charging device mentioned in this document comprises in the embodiment shown here the chargers CH1-CH4 and the converter CON. The mentioned switching device comprises in the embodiment shown here the switches S1-S5.

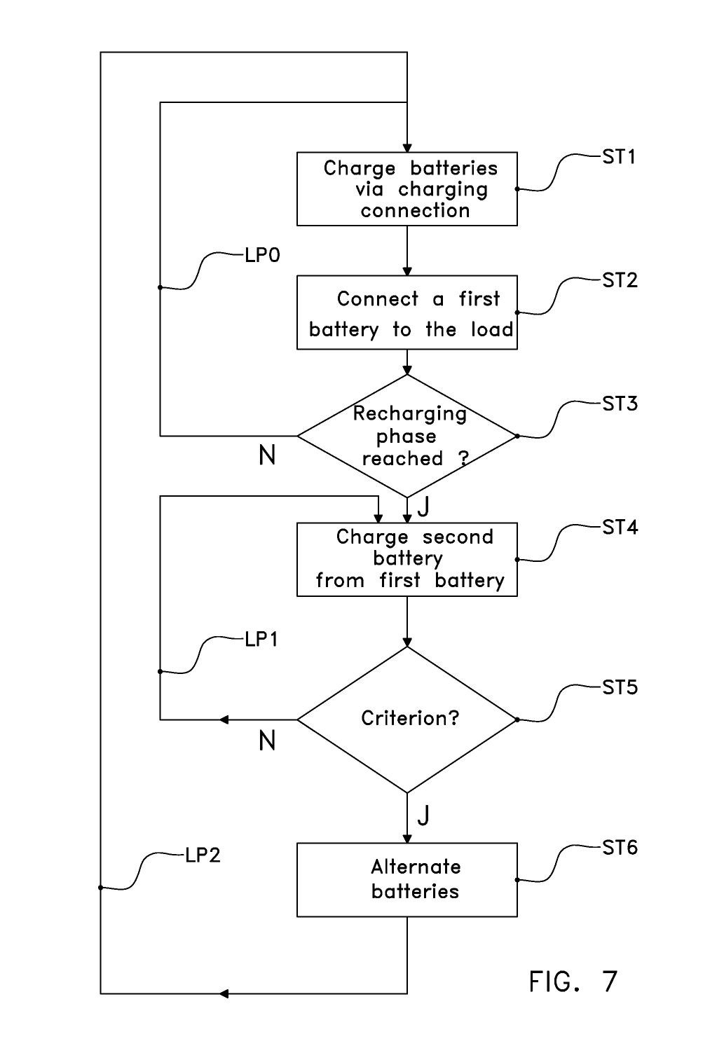

An operation of the switch according to FIG. 6 will be described with reference to FIG. 7. It should be noted that the steps indicated in this document may also be performed in any other suitable sequence. For example, the steps ST1 and ST2 mentioned below may take place simultaneously or after each other in a desired sequence. When the charging connection has been connected to the energy source, the batteries ACC1-ACC4 are charged by the chargers CH1-CH4, as denoted by ST1. Simultaneously, it is also possible that one or more of the batteries are connected to the load and supply energy to the load, as denoted by ST2. When charging the batteries, the control device CONT controls the switch S1 to be in the position shown in FIG. 6, in other words to connect the chargers to the charging connection, and controls the chargers via respective control signals to supply a charging voltage and charging current to the batteries. It is also possible that the switch S1 is controlled in another manner, for example by a control to be disposed between the charging contacts, which control effects a switching of the switch S1 in presence or in absence of the external voltage. In that case, such a control (such as for example an alternating current voltage relay coil) may be fitted to an alternating current voltage side of a not shown rectifier which may serve to convert an alternating current voltage to be offered on the charging contact into a direct current voltage to be supplied to the chargers CH1-CH4.

At the moment when the electrical connection via the charging connection to the external energy source has been interrupted, one or more of the batteries will supply energy to the load (for example batteries ACC1-ACC3 by bringing the switches S2-S4 into the position indicated by a solid line and switch S5 into the position indicated by a dotted line). In this embodiment, battery ACC4 is kept free of the load, in order to prevent a partial discharging of the latter.

As long as it is determined in ST3 that the recharging phase of battery ST4 has not yet been reached (this may take place for example by measuring a voltage, charging current, etc. and to compare it with a predetermined criterion), the charging of the batteries via the charging connection is continued when the external energy source has been connected thereto, and the supply of energy to the load from the first battery, as indicated by the loop LPO is continued as well.

When in ST3 the recharging phase has been reached, further charging of the second battery from the first battery (ST4) occurs in order to enable in this manner a regeneration of the second battery. Now, the control device will control the switch S1 to connect an exit of the converter CONV to entrances of the chargers CH1-CH4, in order to provide in this manner the chargers with a power supply (ST4) via the converter CONV. The control device further controls the chargers CH1-CH4 via the control lines so that the chargers CH1-CH3 (which have been connected to the batteries which supply energy to the load and the converter) have not been activated to proceed to charging, while the charger CH4, which has been connected to battery ACC4, is activated by the control device via the relevant control line to charge battery ACC4 (ST4). Therefore, in this condition, the batteries ACC1-ACC3 supply energy to the converter CONV and the charger CH4 in order to charge the battery ACC4 further, as indicated by ST3, ST4. The aspect shown with reference to FIGS. 6 and 7 is in particular advantageous if the device is connected to an energy source during short periods of time, these periods of time being possibly not sufficiently long to charge the battery. It should be noted that the principle described with reference to FIG. 6 and FIG. 7 may not only be applied in the feed wagon described in this document, but in any battery fed device. The principle described here may also be applied, for example, in a vehicle for displacing, for example shifting away, manure in a shed environment, or a vehicle for removing or picking up manure or other impurities in a shed environment. Of course, many other embodiments are conceivable, wherein the application is not limited to agriculture or cattle breeding.

Owing to the fact that, as described above, after all batteries have been charged via the charging connection, the batteries ACC1-ACC3 will charge the battery ACC4, the battery ACC4 can be charged to such a level, for example completely, through a degeneration of the battery, which would occur in the case of continuous operation in an only partially charged condition, can be prevented or at least reduced. The loop LP1 shown in FIG. 7 may, therefore, be passed through until a moment when it is detected in ST5 that a predetermined criterion, such as a charging condition of the battery to be charged further (in this situation ACC4) is reached. The control device and/or the chargers may be provided for this purpose with suitable measuring device, such as for example voltage measuring device, charging time measuring device, charging current measuring device, etc. When the criterion has been reached, it is proceeded in ST6 to change, in other words to alternate, the batteries. It should be noted that alternating the batteries need not lead to physical alternation of the batteries: the term alternating or changing should be understood in this context as an alternation of a function of the batteries. In the present embodiment, after the criterion has been reached, ACC1, ACC2 and ACC4 may, for example, be used for supplying energy to the load and for charging ACC3, etc., so that each of the batteries ACC1-ACC4 is alternately charged by one or more of the other batteries: in other words, one or more first batteries will supply energy to the load and will charge, via the charging device, a second battery (or a plurality of second batteries), after which it is proceeded to alternation.

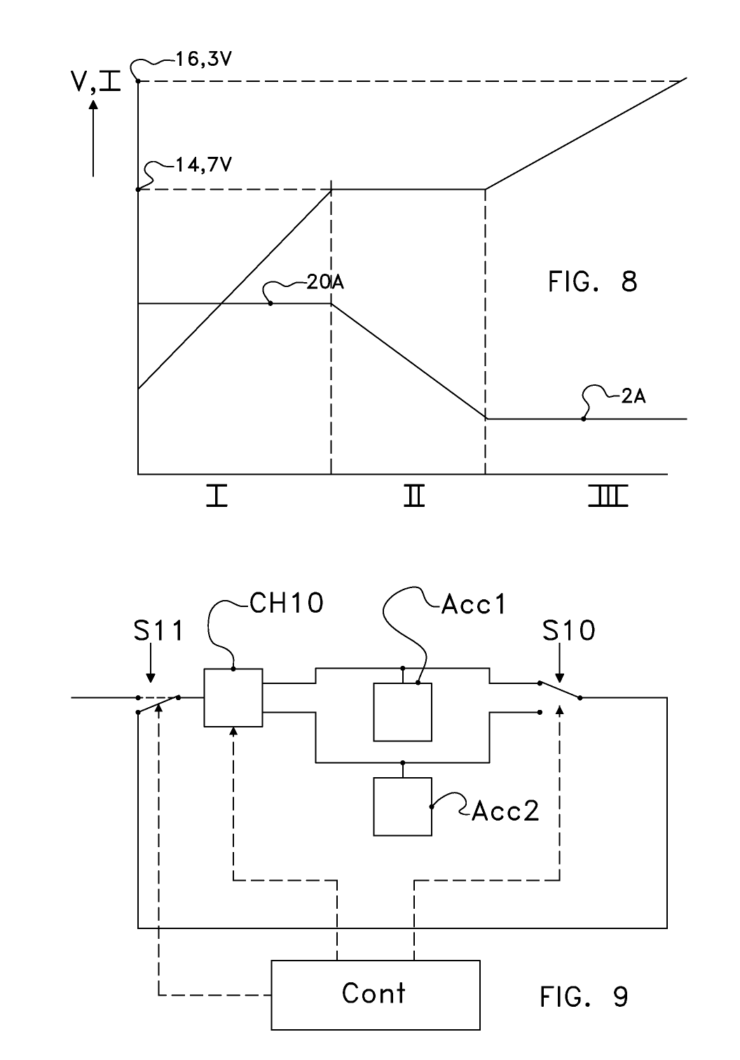

FIG. 8 shows a charging curve according to an aspect of the invention, wherein a charging voltage and a charging current are set out along a vertical axis, and a charging time, charged capacity or quantity related therewith are set out along a horizontal axis. When the battery is charged, it is initially charged, for example by the chargers CH1-CH4 in FIG. 6, with a charging current approaching a maximum admissible charging current of the battery, for example 20 A. During this charging, which is designated as 1 in FIG. 7, the voltage over the battery will increase. When, during charging, the voltage over the battery reaches a predetermined value which is, for example, a predetermined percentage, such as 22.5%, above a nominal voltage of the battery, in this embodiment 12 Volt, it is proceeded to a charging at a constant voltage of, in this embodiment, 14.7 Volt. During this period, which is designated as 11 in FIG. 7, the charging current will decrease. When the charging current has fallen to a further predetermined value, in this embodiment 10% of the charging current in 1, then it is proceeded to the recharging in the recharging phase designated as 111 of the battery, wherein, in this embodiment, in the recharging phase, charging takes place at a constant current which is lower than the previously used charging current, namely 2 A in this embodiment. The recharging is performed until the charging voltage over the battery has increased to 16.3 Volt. The curve as shown here may be passed through in one go, however, as described in the foregoing, this may also take in phases. In particular, the charging in 1 and 11 from the external energy source will only take place at the moments when there is electrical connection to the external energy source, so that the charging in 1 and 11 with energy from the external energy source can take place at intervals.

FIG. 9 shows a schematic diagram as an example of one of the many possible alternatives for the configuration shown in FIG. 6. FIG. 9 shows two batteries designated as ACC1 and ACC2, wherein, via switch S10, the first ACC1 battery or the second ACC2 battery may be connected to the load for supplying energy. Furthermore, the battery connected to the load is connected to an entrance of the charging device CH10 via switch S11. Incidentally, in FIG. 9 return connections or mass connections have been omitted for the sake of simplicity. When the device has been connected to an external energy source, the charging device may be fed from said external energy source via S11, in order to charge the batteries ACC1 and ACC2 in this manner. According to the above-described principle, the charger may, fed from one of the batteries ACC1 or ACC2, charge or recharge the other batteries, as illustrated by means of the flowchart according to FIG. 7. The charging device and switches are controlled by a control device CONT. The charging device may charge one of the batteries or both of the batteries, controlled by the control device.

Thus, the invention has been described by reference to certain embodiments discussed above. It will be recognized that these embodiments are susceptible to various modifications and alternative forms well known to those of skill in the art. Accordingly, although specific embodiments have been described, these are examples only and are not limiting upon the scope of the invention. The person skilled in the art will be able to apply various modifications and adaptations within the scope of the invention, the scope of the protection for the invention being determined by the accompanying claims.

What is claimed is:

1. A feed wagon for feeding animals comprising:
an autonomous vehicle,
a container for housing feed, wherein the container comprises:
at least one aperture for filling and emptying the container, and
an axial axis, and
is substantially cylindrical and rotatable about the axial axis.

2. The feed wagon according to claim 1, wherein:
the container has an operative position for at least one of receiving feed and mixing feed and an unloading position for unloading the feed, and
wherein the feed wagon further comprises a connection between the autonomous vehicle and the container,
wherein the connection comprises a tilt axis and wherein the cylindrical container is tiltable about the tilt axis between the operative position and the unloading position relative to the autonomous vehicle.

3. The feed wagon according to claim 2, wherein the tilt axis of the connection is substantially perpendicular to the axial axis of the container.

4. The feed wagon according to claim 2, wherein the tilt axis is at least one of rotatable and adjustable.

5. The feed wagon according to claim 1, wherein a profile section is disposed at the inner wall of the container, and wherein the profile section protrudes relative to the inner wall of the container.

6. The feed wagon according to claim 5, wherein the profile section extends in a helical line.

7. The feed wagon according to claim 1, wherein the autonomous vehicle comprises wheels and a drive for driving at least one wheel, wherein the drive comprises an electric motor for each wheel to be driven.

8. The feed wagon according to claim 1, further comprising at least one weighing device for determining the mass of the feed present in the container.

9. The feed wagon according to claim 8, wherein an outgoing signal of the weighing device is supplied as an ingoing signal to a control of the feed wagon, and wherein the control is configured to control at least one of: a tilting of the container, a driving speed of the wagon, a direction of rotation of the container, and an rpm of the container,
in dependence on a change over time of the mass of the feed measured by the weighing device.

10. The feed wagon according to claim 8, wherein the weighing device comprises a detector for determining at least one of an amount of feed present on a particular surface located outside the container and a distribution of the feed over a particular surface located outside the container.

11. The feed wagon according to claim 1, further comprising a slide element for displacing feed lying on a surface over which the autonomous vehicle moves.

12. The feed wagon according to claim 1, further comprising:
at least two chargeable batteries,
a charging connection for effecting an electrical connection between the feed wagon and an energy source,
a charging device for charging the batteries,
a switching device for effecting an electrical connection between one of the batteries and a load to be supplied with energy by the battery, and for effecting an electrical connection of an entrance of the charging device to another one of the batteries, and
a control device that is configured to control at least one of the switching device and the charging device for:
a) charging the batteries through the charging device when the charging connection has been connected to the energy source;
b) connecting a first one of the batteries to the load in order to supply electrical energy to the load;
c) operating the charging device in order to charge the second battery, the first battery supplying electrical energy to the charging device;
d) repeating b) and c) after a predetermined criterion has been reached, wherein in b) the second battery has been connected to the load in order to supply energy to the load and in c) the first battery is charged by the charging device from the second battery.

13. The feed wagon according to claim 12, wherein the predetermined criterion comprises a charging condition of the second battery, and wherein the feed wagon further comprises a measuring device for measuring the charging condition of the second battery.

14. The feed wagon according to claim 12, wherein the predetermined criterion comprises one or more of a voltage, a voltage development, an impedance and an impedance development of the second battery and wherein the feed wagon further comprises a measuring device for monitoring the relevant criterion.

15. The feed wagon according to claim 12, wherein the control device is further configured to measure a charging condition of the second battery previously to step c) and only to proceed to step c) when the second battery has reached a recharging phase.

16. The feed wagon according to claim 12, wherein the control device is configured to disconnect the second battery from the load in step b).

17. The feed wagon according to claim 12, wherein the charging device comprises a voltage converter for converting the voltage received via the charging connection into a charging voltage for the batteries, and for converting the voltage received from the at least one first battery into a charging voltage for the second battery.

18. The feed wagon according to claim 12, wherein the control device performs d) after having performed step a) at least twice.

19. A system for feeding animals, comprising:
a feed wagon comprising:
an autonomous vehicle,
a container for housing feed, wherein the container:
comprises at least one aperture for filling and emptying the container,
comprises an axial axis, and
is substantially cylindrical and rotatable about the axial axis,
a filling station for filling the container of the feed wagon,
a storage for at least one sort of feed, and
a conveyor for conveying at least one sort of feed from the storage to the filling station.

20. The system according to claim 19, further comprising a rail for guiding the autonomous vehicle.

21. The system according to claim 20, wherein the autonomous vehicle is arranged to be suspended from the rail.

22. The system according claim 19, wherein the autonomous vehicle comprises one or more chargeable batteries, and wherein the filling station comprises an energy source for supplying energy to the feed wagon for recharging the chargeable batteries.

23. The system according to claim 19, further comprising a mixing device for mixing different types of feed.

24. The system according to claim 19, further comprising a drive mechanism for rotating the container when the feed wagon is located in the filling place.
